(19) United States
(12) Patent Application Publication
(10) Pub. No.: US 2003/0164258 A1
(43) Pub. Date: Sep. 4, 2003

(54) Flotation system for snow mobile

(76) Inventors: Jerry Lalonde, Hanmer (CA); Dan Martysz, Serpent River (CA)

Correspondence Address: Jerry Lalonde, 4914 Morrie Court, Hanmer, ON, P3P-1H2, CA

(21) Appl. No.: 10/086,257

(22) Filed: Mar. 4, 2002

(51) Int. Cl. B60R 21/00

(52) U.S. Cl. 180/271

(57) ABSTRACT

An air bag safety floatation system for vehicles in danger of sinking. In the preferred mode, the device is installed on a snow mobile on the handle bar and steering section thereof. The system comprises a CO2 cartridge with a supply line to fill an air bag, to allow the machine on which it is mounted to float for a sufficient period of time to allow the user to escape to safety. Importantly, this system may be activated manually through usage of a manual trigger mechanism, which may be armed by the user when traveling across frozen lakes or rivers, and disarmed by the user when in other areas. A locking pin is also utilized for the purposes of user safety. In addition, the system may be deployed through the use of a pressure switch, which is automatically activated upon being submerged into water. Once deployed, the device serves as a survival tool for those operating machines that fall through ice on lakes or rivers, preventing significant damage to the snow mobile in the process. Finally, the system inhibits the leakage of fluids such as gasoline and oil into the water, thereby providing additional safety and largely preventing pollution.

### BACKGROUND OF THE INVENTION

1. Field of the Invention

The present invention is an air bag safety floatation system for vehicles in danger of sinking. In the preferred mode, the device is installed on a snow mobile on the handle bar and steering section thereof. The system comprises a CO2 cartridge with a supply line to fill an air bag, to allow the machine on which it is mounted to float for a sufficient period of time to allow the user to escape to safety.

2. Description of the Prior Art

Numerous innovations for flotation devices have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 6,070,546, invented by Downey et al., entitled “Snowmobile Floatation Device”

The Downey invention provides a flotation device for a snowmobile including a plurality of preferably self-contained air bag modules having inflatable bladders affixed to the exterior of a snowmobile and adapted to inflate when a water detection device such as a float sensor is exposed to water. The inflated bladders supply sufficient buoyancy to maintain the snowmobile afloat and stable, and in the preferred embodiment are configured to provide an escape means for the occupants of the snowmobile who can use the bladder as a buoyant platform to escape to solid ice.

2. U.S. Pat. No. 5,682,832, invented by Millard, entitled “Snowmobile Quick Deployment Floats”

The Millard invention describes a flotation device for snowmobiles that can be quickly deployed in the event of breaking through the ice when traveling on a frozen lake, river or other body of water, and, in addition, if desired, such device may be deflated or inflated independent of power sources beyond those supplied by the subject snowmobile itself.

3. U.S. Pat. No. 5,515,802, invented by Bree, entitled “Buoyancy Device”

The Bree invention describes a buoyancy device comprised of an inflatable shell of resiliently deformable molded plastic material. The shell has a tubular wall having zones in which the wall is indented so that it is capable of easy deformation in the axial direction relative to cylindrical portions of the wall adjacent each side of the zones. At each indentation, the wall comprises two substantially crescent-shaped portions which project inwardly from the cylindrical portions. The shell has integrally molded lugs for assisting mounting of the device on the curved side of a boat. The crescent-shaped portions of the wall and the lugs are located on opposite sides of the shell.

4. U.S. Pat. No. 5,150,662, invented by Boyd et al., entitled “Snowmobile Floatation System”

The patent to Boyd et al. describes a flotation system designed to be incorporated into an existing snowmobile and including a plurality of floats which may be inflated either selectively or automatically. The device is intended to be incorporated into a snowmobile which is used on ice covered bodies of water. Sometimes, during such use, the ice breaks causing the snowmobile to sink and thereby be destroyed. Through the use of the present invention, flotation is provided to maintain the snowmobile in a floating position to allow safe retrieval.

5. U.S. Pat. No. 4,893,692, invented by Smith, entitled “Snowmobile”

The patent to Smith describes a floatable snowmobile make up of a one-piece molded plastics body comprising an engine compartment with a recess defined therein for receiving an engine and accessories; an elongated seat-bench provided with a recess for receiving a track assembly; and a cargo support extending rearwardly thereof. The molded body includes a rigid skin forming the shell defining an enclosed cavity in which there is provided an expanded closed-cell foam core of water-buoyant material. The skis are constructed as pontoons of similar construction to the body, and the whole snowmobile can float with a portion thereof out of the water so as to support a rider clear of the water in the event the snowmobile falls through ice.

6. U.S. Pat. No. 4,887,541, invented by Rodemann, entitled “Deployable Floatation Device”

The patent to Rodemann describes a deployable flotation device including buoyancy members tightly packed in a container mechanism in which the container is either permanently mounted within a watercraft or removably deployed for periodic recertification and receives inner and outer buoyancy members for providing positive buoyancy in a watercraft over a shelf life of up to five years. In a modification a single outer container may be used. A particular composition for the buoyancy member suitable for the marine environment is disclosed. Deployment may be manual, semi-automatic, or automatic depending on the requirements of particular watercraft.

7. U.S. Pat. No. 4,864,961, invented by Slonski, entitled “Auxiliary Floatation System”

The patent Slonski describes an auxiliary flotation apparatus to provide supplemental flotation for a vessel which may be in danger of sinking. The apparatus is a self-contained canister capable of being connected to a source of pressurized air. To assure stability of the disabled vessel, two or more of the canisters would preferably be mounted at an outboard end to each side of the hull of the vessel at spaced locations below the water line. Should the need arise, the source of pressurized air can be manually or automatically activated for introduction into the canister. In response to the pressurized air, a projectile is propelled in a direction away from the vessel and caused to rupture a frangible membrane located substantially flush with the hull of the vessel. The projectile proceeds far beyond the vessel and draws with it an attached inflatable tubular sheath of flexible, air impermeable sheet material. The tubular sheath has a continuous terminal rim distant from the projectile sealingly attached to an inboard end of the canister. When the projectile has reached its limit of travel, the sheath becomes completely filled with air and expands to its full size as it extends outwardly from the hull, thereby providing buoyancy for the vessel.

8. U.S. Pat. No. 4,108,453, invented by Lavalier, entitled “Snowmobile Floatation Ski”

The Lavalier invention describes a snowmobile ski including an elongate plywood body member and a flexible, air-impervious material covering the bottom surface of the body member. The body has a generally upwardly curved forward end and a width substantially greater than conventional snowmobile skis to provide support in soft snow, slush, ice, and the like. The flexible material covering the bottom surface of the body member is attached, and hermetically sealed, to the bottom surface along the outer margins and a longitudinal center line of the body member by a thin metal strap and a series of spaced bolts.

9. U.S. Pat. No. 6,199,648, invented by Kanan, entitled “Floatation And Snow Exclusion Components For A Suspension System For A Snowmobile”

The Kanan invention describes an improved suspension mechanism for snowmobiles. In particular, an additional set of skis which provide support and stability to a snowmobile when the snowmobile is in deep powder is described. The skis also provide an effective structure for preventing the build-up of snow and ice in the snowmobile's suspension wells. Additionally, a suspension well skirt which provides a barrier from snow for a snowmobile's suspension well is described. The additional skis, in conjunction with the skirt, allow a snowmobile to be propelled quickly through deep snow as well as provide increased steerability to the snowmobile when it is in deep snow.

For the purposes of example, the first above-listed patent to Downey describes a flotation system which relies upon multiple air bags, which are deployed only automatically—not by the user of the snow mobile. In addition, the above-listed patent to Millard teaches the usage of multiple large floats that are located under the foot steps and upon the skis of the snow mobile.

The other aforementioned prior art patents illustrate various devices relating to flotation of machines, including several devices designed for boats, detachable canister-type air devices for vehicles, flotation devices that utilize foam substances rather than air, and flotation devices built directly into the hull or chassis of vehicles.

In contrast to all of the above, the present invention comprises a CO2 cartridge that fills an air bag to allow a machine to float, and is installed on the handle bar and steering section of a snow mobile. Importantly, this system may be deployed manually by the user engaging a trigger mechanism, in which case the system further comprises a locking pin for safety purposes. Alternatively, the system may be deployed automatically through usage of a pressure switch when submerged in water. The system is relatively small and lightweight, and requires very little modification to the previously-existing snow mobile.

### SUMMARY OF THE INVENTION

As noted, the present invention is an air bag safety floatation system for vehicles in danger of sinking. In the preferred mode, the device is installed on a snow mobile on the handle bar and steering section thereof.

The system comprises a CO2 cartridge with a supply line to fill an air bag, to allow the machine on which it is mounted to float for a sufficient period of time to allow the user to escape to safety. Importantly, this system may be activated manually through usage of a manual trigger mechanism, which may be armed by the user when traveling across frozen lakes or rivers, and disarmed by the user when in other areas. A locking pin is also utilized for the purposes of user safety. In addition, the system may be deployed through the use of a pressure switch, which is automatically activated upon being submerged into water.

Once deployed, the device serves as a survival tool for those operating machines that fall through ice on lakes or rivers, preventing significant damage to the snow mobile in the process. Finally, the system inhibits the leakage of fluids such as gasoline and oil into the water, thereby providing additional safety and largely preventing pollution.

In light of the foregoing, it is generally an object of the present invention to provide a device that keeps a snowmobile afloat when the same falls through ice in lakes, rivers, and the like.

It is a further object of the invention to provide an item that protects users and snow mobiles alike, in a manner that does not materially alter previously existing machines.

It is an additional object of the invention to provide a safety device that does not add significant manufacturing cost to the snowmobiles upon which they are utilized.

It is also an object of the invention to provide a system that is relatively lightweight in nature, enabling the snowmobile to function in the manner it is intended.

It is a further object of the invention to provide an assembly that utilizes additional safety devices, such as at least one locking pin, to better protect the snowmobile operators.

It is another object of the invention to provide a device that is installed on a snow mobile on the handle bar and steering section thereof, creating an effective system that does not interfere with operation of the machine.

It is a further object of the present invention to provide a device that may include colors, graphics, or indicia thereon, functioning to enhance the overall appearance of the device upon which it is installed.

It is an additional object of the present invention to provide a system that may be activated manually by a user, or alternatively by a pressure switch that is activated when the snow mobile becomes submerged in water.

Finally, it is an object of the present invention to provide a system that effectively prevents spillage of fuels and oils from the snowmobile, providing environmental benefits in addition to the safety benefits noted above.

The novel features which are considered characteristic for the invention are set forth in the claims. The invention itself, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

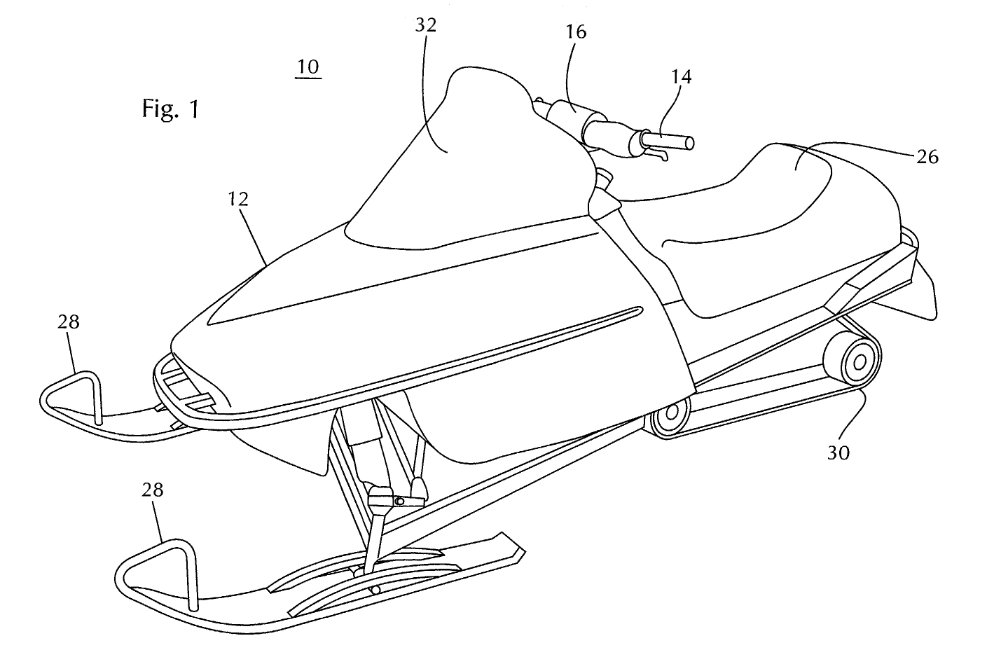

FIG. 1 is a front, three-quarter perspective view of a snow mobile incorporating the present invention, in the preferred mode.

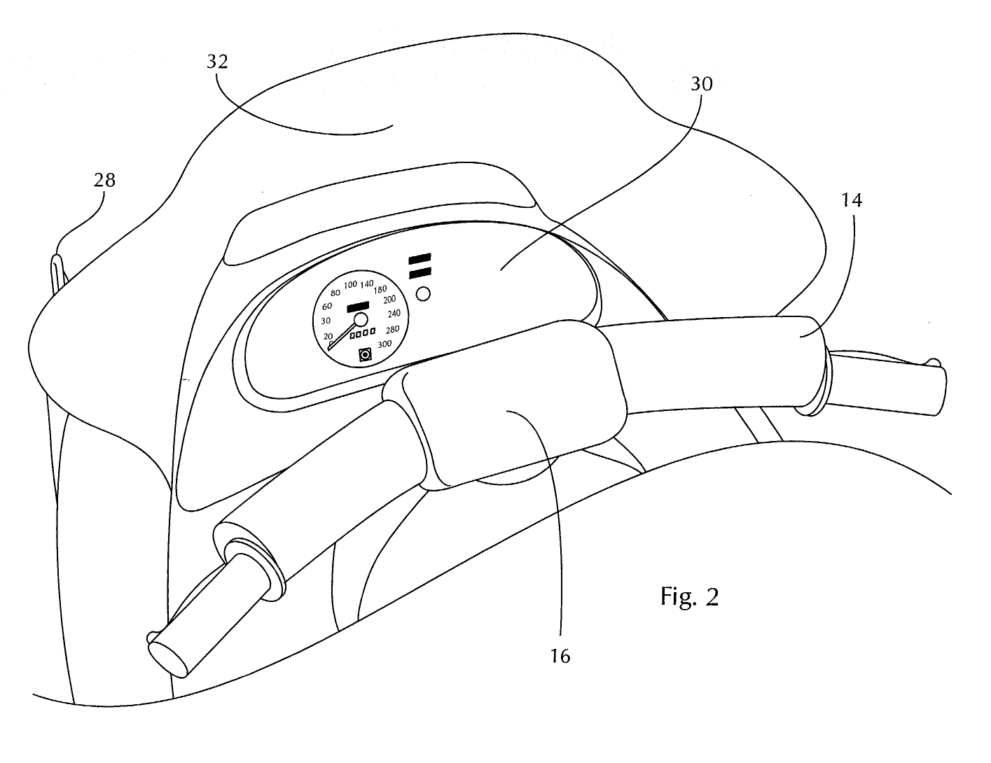

FIG. 2 is a front perspective view of the steering assembly of a snow mobile, indicating the intended location of the present invention in the preferred mode.

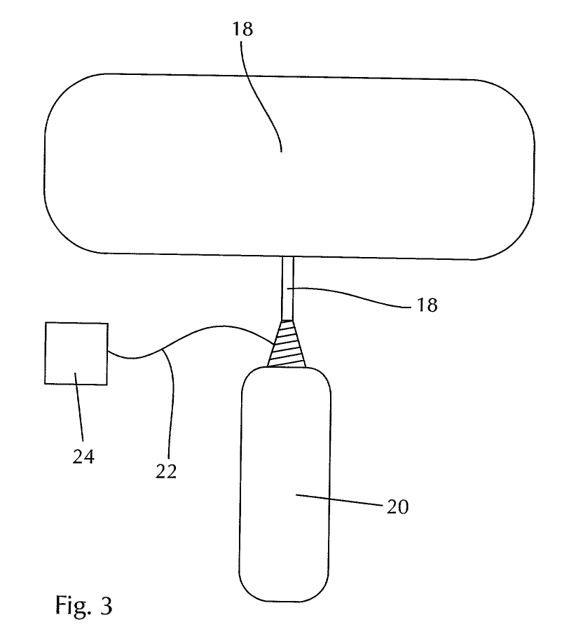

FIG. 3 is a front diagram view of the principal components of the present invention, in the preferred mode.

### DETAILED DESCRIPTION OF THE PREFERRED EMBODIMENT

Referring to FIG. 1, which is a front, three-quarter perspective view of a snow mobile incorporating the present invention, in the preferred mode; FIG. 2, which is a front perspective view of the steering assembly of a snow mobile, indicating the intended location of the present invention in the preferred mode; and FIG. 3, which is a front diagram view of the principal components of the present invention, in the preferred mode (for the purposes of example only):

The first two drawings depict a snow mobile (12), which is intended to represent a typical machine upon which the present invention may be installed or adapted. Accordingly, the snow mobile (12) comprises a steering assembly (14), as well as a seat (26), ground engaging components (28), drive assembly (30), and upper housing member (32).

As best depicted in FIG. 2, in the preferred mode of the invention the steering assembly (14) comprises a housing (16) at a center portion thereof, the housing (16) comprising an air bag member therein. Importantly, the housing (16) is of a size and configuration which does not interfere with the user's ability to view the dashboard display (30), or to see ahead of the snow mobile (12) for steering purposes.

Similarly, the housing (16) extends towards the user from the steering assembly (14) in a relatively small degree, functioning to allow the user to comfortably sit atop the snowmobile absent any interference or discomfort resulting from same.

As best indicated in FIG. 3, the principal components of the assembly of the present invention are the housing (16), which contains the air bag as previously noted, a supply line (18), a cartridge (20), line (22), and safety mechanism (24).

Specifically, in the preferred mode of production, the air bag is of a previously determined capacity, according to the size and weight of the machine upon which the system is installed. Cartridge (20) is preferably a CO2 cartridge, consistent with several of those found in the prior art. The capacity of the cartridge is previously determined, according to the size and weight of the machine upon which the system is installed. Supply line (18) is a line sufficient in length to accomplish the purposes of the present invention, but in a location and configuration which does not interfere with the hands or legs of the snow mobile user.

Importantly, as noted herein, the system may be activated manually through usage of a manual trigger mechanism, which may be armed by the user when traveling across frozen lakes or rivers, and disarmed by the user when in other areas. The safety mechanism (24) may comprise a locking pin, utilized for the purpose of insuring that the air bag system is not deployed at inappropriate or undesired instances.

In addition, as previously noted, the air bag system may be deployed through the use of a pressure switch, which is automatically activated upon the snow mobile being submerged into water.

As such, once engaged either manually or automatically, the system causes the supply line (18) to fill the air bag, allowing the machine on which it is mounted (12) to float for a sufficient period of time to allow the user to escape to safety. Thus, the device serves as a survival tool for those operating snow mobiles that fall through ice on lakes or rivers, as is relatively common in such activities. This is because when the air bag is deployed from the housing (16), the user is able to remain afloat atop the snow mobile (12), by either remaining atop the seat (26), or by moving upon the hood or top area (32). Importantly, both locations are above the water line of the submerged snow mobile (12), as the assembly of the present invention is placed in a location that keeps the upper portions of the machine in the air.

It should be noted that the system also prevents significant damage to the snow mobile in the process. Such machines are relatively expensive in nature, and require significant maintenance to perform in the intended manner. Therefore, prevention of damage to the vehicle presents a highly desirable product for manufacturers, retailers, and end users alike.

Furthermore, the system of the present invention inhibits the leakage of fluids such as gasoline and oil into the water, thereby largely preventing pollution to the lake or river upon which the snow mobile is traveling.

The system may be factory installed on new snow mobiles, providing the benefits of the present invention to those purchasing the latest machines. Alternatively, the system may easily be retrofitted to and installed upon previously existing snow mobiles, providing significant safety benefits to thousands of users with their current machines.

Lastly, in all instances, the system may comprise indicia thereon in the form of previously determined text, graphics, designs, and colors. For the purposes of example, such may indicate the location of the trigger mechanism, or may simply enhance the appearance of the snow mobile in question.

With regards to all descriptions and graphics, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A flotation system for a snow mobile comprising:
a housing located upon a steering area of a snow mobile in a center portion of a handle bar thereof, the housing comprising an air bag therein, the air bag of a previously determined capacity according to size and weight of the snow mobile,
a supply line connected to the air bag, a CO2 cartridge connected to the supply line, the CO2 cartridge of a previously determined capacity according to size and weight of the snow mobile,
at least one line extending outwardly from the CO2 cartridge, the at least one line engaging a safety mechanism, which functions to control engagement and disengagement of the air bag system,
the system functioning to allow the snow mobile on which it is mounted to float for a sufficient period of time to allow a user to escape to safety.

2. The flotation system for a snow mobile as described in claim 1, wherein the system is factory installed on new snow mobiles.

3. The flotation system for a snow mobile as described in claim 1, wherein the system is retrofitted to and after-market installed on previously existing snow mobiles

4. The flotation system for a snow mobile as described in claim 1, wherein the system is activated automatically through usage of a pressure switch that engages the cartridge and air bag when the switch is in contact with or submerged within water.

5. The flotation system for a snow mobile as described in claim 1, wherein the system is activated manually, through usage of a trigger mechanism that engages the cartridge and air bag when engaged by a user.

6. The flotation system for a snow mobile as described in claim 5, wherein the trigger switch is able to be armed by a user when the snow mobile is traveling over dangerous areas, and disarmed when the snow mobile is traveling over other areas.

7. The flotation system for a snow mobile as described in claim 1, wherein the system further utilizes a locking device to securely control the engagement of the cartridge and air bag.

8. The flotation system for a snow mobile as described in claim 1, wherein the system further utilizes a safety pin mechanism to securely control the engagement of the cartridge and air bag.

9. The flotation system for a snow mobile as described in claim 1, wherein the system comprises indicia thereon in the form of previously determined text, graphics, designs, and colors.

10. The flotation system for a snow mobile as described in claim 1, wherein the capacity of the air bag is variable.

11. The flotation system for a snow mobile as described in claim 1, wherein the capacity of the air cartridge is variable.
